(19) United States
(12) Patent Application Publication
(10) Pub. No.: US 2012/0163339 A1
(43) Pub. Date: Jun. 28, 2012

(54) APPARATUS AND METHOD FOR GROUP COMMUNICATION

(75) Inventors: Nak Woon SUNG, Daejeon (KR); Sook Jin Lee, Daejeon (KR)

(73) Assignee: ELECTRONICS AND TELECOMMUNICATIONS RESEARCH INSTITUTE, Daejeon (KR)

(21) Appl. No.: 13/253,224

(22) Filed: Oct. 5, 2011

(30) Foreign Application Priority Data
Dec. 23, 2010 (KR) 10-2010-0133607

(51) Int. Cl. H04W 36/00; H04W 72/00

(52) U.S. Cl. 370/331; 370/329

(57) ABSTRACT

An apparatus for group communication in a base station through a plurality of terminals connected to a terminal coupler receives periodic reports of Carrier to Interference Noise Ratio (CINR) from the plurality of terminals, calculates the moving average CINR and makes a BS-initiated handover decision for the plurality of terminals, and controls the plurality of terminals to simultaneously perform handover to a target base station.

### CROSS-REFERENCE TO RELATED APPLICATION

This application claims priority to and the benefit of Korean Patent Application No. 10-2010-0133607 filed in the Korean Intellectual Property Office on Dec. 23, 2010, the entire contents of which are incorporated herein by reference.

### BACKGROUND OF THE INVENTION

(a) Field of the Invention

The present invention relates to a group communication method and apparatus. More particularly, the present invention relates to an apparatus and method for providing a service to a terminal equipment by group communication by connecting a plurality of terminals independently connectable to a base station to one terminal coupler.

(b) Description of the Related Art

Third generation (3G) and fourth generation (4G) mobile communication systems provide a high-speed service via a wireless channel, which is a limited resource, by employing an Orthogonal Frequency Division Multiplexing (OFDM) scheme or Multi Input Multi Output (MIMO) scheme. Also, in the third generation and fourth generation mobile communication systems, a terminal is attached to a plurality of carriers and provides a high-speed service.

However, the maximum speed at which a single terminal can support a service in a wireless environment is limited compared to a wired environment, and the terminal may not be able to attain the maximum speed depending on the state of the wireless channel. Meanwhile, the amount of high-capacity and high-speed multimedia data in a user's internet environment is increasing fast, and such high-capacity and high-speed multimedia data cannot be serviced by one terminal.

Moreover, if a terminal participating in group communication within a base station moves, handover is performed for each of the terminals in the group. Thus, the handover timing and target base station of each terminal in the group may differ, and this can render communication between a terminal equipment and a server impossible.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a group communication apparatus, which can provide a service that is not supported by a single terminal to a terminal equipment.

Further, the present invention provides a group communication apparatus and method, which instructs a plurality of terminals belonging to the same group to perform a simultaneous handover.

An exemplary embodiment of the present invention provides a method of group communication in a base station. The group communication method includes: allocating respective connection identifiers to a plurality of terminals connected to a terminal coupler; allocating the same group identifier to the connection identifiers of the plurality of terminals; upon receiving uplink packets of a terminal equipment from the plurality of terminals through the terminal coupler, realigning the uplink packets according to the sequence numbers of the uplink packets and transmitting the uplink packets to a network; and upon receiving downlink packets directed to the terminal equipment from the network, assigning sequence numbers to the downlink packets and transmitting the downlink packets to the plurality of terminals.

Another exemplary embodiment of the present invention provides an apparatus of group communication in a base station. The group communication apparatus includes a connecting unit, a group management unit, and a handover decision unit. The connecting unit sets up a connection with a plurality of terminals connected to a terminal coupler and allocates connection identifiers to the plurality of terminals. The group management unit allocates the same group identifier to the connection identifiers of the plurality of terminals connected to the terminal coupler and manages the plurality of terminals in one group. The handover decision unit receives communication quality information from the plurality of terminals of the group, calculates the moving average of the communication quality information, and makes a handover decision for the plurality of terminals of the group if the moving average is less than a reference value.

Still another exemplary embodiment of the present invention provides an apparatus for performing group communication. The group communication apparatus includes a connecting unit, a group management unit, and a service providing unit. The connecting unit sets up a connection with a terminal equipment and a plurality of terminals independently access to a base station. The group management unit manages the plurality of terminals in one group. The service providing unit assigns sequence numbers to uplink packets received from the terminal equipment and forwards the uplink packets to the plurality of terminals according to scheduling, and receives downlink packets assigned with sequence numbers from the plurality of terminals, realigns the downlink packets according to the sequence numbers, and forwards the downlink packets to the terminal equipment.

### BRIEF DESCRIPTION OF THE DRAWINGS

FIG. 1 is a view showing a mobile communication system according to an exemplary embodiment of the present invention.

FIG. 2 is a view showing a method for group management in a base station according to an exemplary embodiment of the present invention.

FIG. 3 is a view showing handover of a terminal connected to a terminal coupler according to an exemplary embodiment of the present invention.

FIG. 4 is a view showing a method for setting up a network connection in a mobile communication system according to an exemplary embodiment of the present invention.

FIG. 5 is a view showing a handover method of a plurality of terminals connected to a terminal coupler according to an exemplary embodiment of the present invention.

FIG. 6 is a view showing a method for disconnecting a terminal connected to a terminal coupler according to an exemplary embodiment of the present invention.

FIG. 7 is a view showing a terminal coupler according to an exemplary embodiment of the present invention.

FIG. 8 is a view showing a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

In this specification, a mobile station (MS) may designate a terminal, a mobile terminal (MT), a subscriber station (SS), a portable subscriber station (PSS), user equipment (UE), an access terminal (AT), and so on. Moreover, the mobile station may include all or a part of functions of the terminal, the mobile terminal, the subscriber station, the portable subscriber station, the user equipment, the access terminal and so on.

In this specification, a base station (BS) may designate an access point (AP), a radio access station (RAS), a node B (Node B), an evolved node B (eNode B), a base transceiver station (BTS), a mobile multihop relay (MMR)-BS, and so on. Further, the base station may include all or a part of functions of the access point, the radio access station, the node B, the eNode B, the base transceiver station, the MMR-BS, and so on.

Now, a group communication apparatus and method according to an exemplary embodiment of the present invention will be described in detail with reference to the drawings.

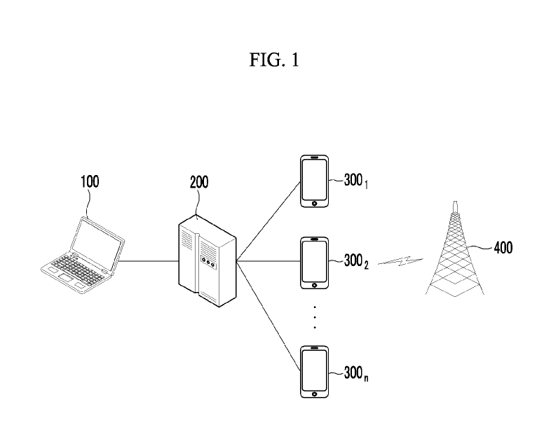

FIG. 1 is a view showing a mobile communication system according to an exemplary embodiment of the present invention.

Referring to FIG. 1, a mobile communication system comprises a terminal equipment 100, a terminal coupler 200, a plurality of terminals 300₁ to 300ₙ, and a base station 400.

A terminal equipment 100 is a terminal, such as a laptop, at an end point, which is capable of executing an internet application program, and is connected to the terminal coupler 200 and communicates with the base station 400 through at least one of the plurality of terminals 300₁ to 300ₙ connected to the terminal coupler 200.

The terminal coupler 200 is connected to the terminal equipment 100 and the plurality of terminals 300₁ to 300ₙ, and plays the role of relaying a service between the terminal equipment 100 and the plurality of terminals 300₁ to 300ₙ.

Specifically, the terminal coupler 200 sequentially assigns sequence numbers to uplink packets [SDU(Service Data Unit)] received from the terminal equipment 100, and forwards them to the terminals 300₁ to 300ₙ according to a scheduling policy. Moreover, the terminal coupler 200 receives downlink packets [SDU(Service Data Unit)] from the terminals 300₁ to 300ₙ connected thereto, and realigns them according to the sequence numbers and forwards them to the terminal equipment 100.

Such a terminal coupler 200 does not interfere with the operation of the terminals 300₁ to 300ₙ.

The plurality of terminals 300₁ to 300ₙ, which are independently attachable to the base station 400, can be independently operated.

In an exemplary embodiment of the present invention, the plurality of terminals 300₁ to 300ₙ connected to the terminal coupler 200 forms one group and perform group communication with the base station 400, and provide a high-capacity and high-speed service to the terminal equipment 100 through the terminal coupler 200.

The terminals 300₁ to 300ₙ of this type receive a handover indication from the base station 400 and simultaneously perform handover to a target base station.

In general, handovers include an MS-initiated handover initiated by a terminal and a BS-initiated handover initiated by a base station. As for the MS-initiated handover, if the terminals 300₁ to 300ₙ participate in group communication, each of the terminals 300₁ to 300ₙ moves to a target base station through a handover decision process, so the handover timing and target base station of each of the terminals 300₁ to 300ₙ may differ. If the handover timings or target base stations of the terminals 300₁ and 300₂ differ from each other, the terminal coupler 200 forwards some packets received by the terminal equipment 100 to the target base station of the terminal 300₁ through the terminal 300₁ and some packets received by the terminal equipment 100 to the target base station of the terminal 300₂ through the terminal 300₂. That is, if the target base stations of the terminals 300₁ and 300₂ differ from each other, some of the packets forwarded from the terminal equipment 100 are forwarded to the target base station of the terminal 300₁ and some of them are forwarded to the target base station of the terminal 300₂. Thus, the packets forwarded from the terminal equipment 100 cannot be properly realigned. Therefore, the terminals 300₁ to 300ₙ resolve the aforementioned problem by receiving a handover indication from the base station 400 and simultaneously performing handover.

The terminals 300₁ to 300ₙ periodically report communication quality information to the base station 400 periodically receiving the current service so as to enable BS-initiated handover. The communication quality information may be Carrier to Interference Noise Ratio (CINR).

The base station 400 manages the terminals 300₁ to 300ₙ connected to the terminal coupler 200, and realigns uplink packets forwarded from the same group according to the sequence numbers and transmits them to a network (not shown).

Upon receiving downlink packets to be forwarded from the network to the terminal equipment 100, the base station 400 assigns sequence numbers to the downlink packets and forwards them to the terminals 300₁ to 300ₙ according to a scheduling policy. By doing so, services with such capacity and/or speed that a single terminal is unable to support can be provided to the terminal equipment 100 through the terminals 300₁ to 300ₙ and the terminal coupler 200.

Moreover, upon receiving communication quality information from the terminals 300₁ to 300ₙ of the same group, the base station 400 calculates the moving average of the communication quality information of the terminals 300₁ to 300ₙ of the same group. If the moving average of the communication quality information of the terminals 300₁ to 300ₙ of the group is less than a reference value, the base station 400 considers that a group handover trigger condition is met, and makes a BS-initiated handover decision.

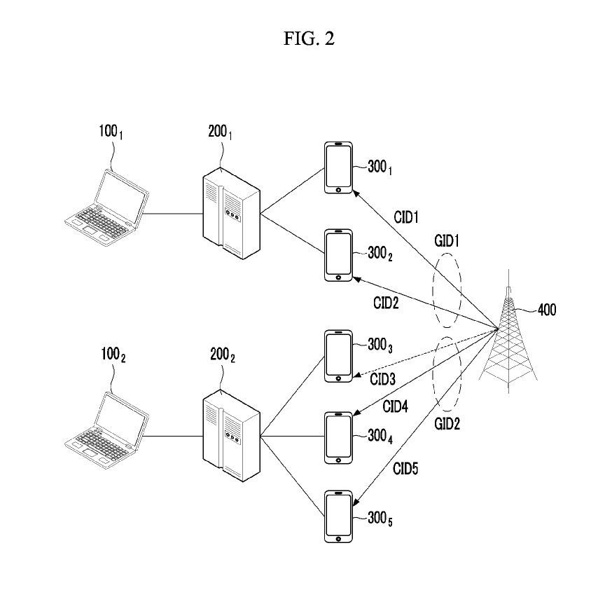

FIG. 2 is a view showing a method for group management in a base station according to an exemplary embodiment of the present invention.

FIG. 2 illustrates two terminal equipments 100₁ and 100₂ and two terminal couplers 200₁ and 200₂ for convenience of explanation.

The terminals 300₁ and 300₂ are connected to the terminal coupler 200₁ to constitute a group, and the terminals 300₃ to 300₅ are connected to the terminal coupler 200₂ to constitute a group.

These terminals 300₁ to 300₅ perform a network entry procedure to provide services. That is, the terminals 300₁ to 300₅ set up a connection with a base station 400. At this point, the base station 400 allocates connection identifiers CID1 to CID5 to the respective terminals 300₁ to 300₅. Each of the connection identifiers may comprise a basic connection identifier and a traffic connection identifier.

If the terminals 300₁ and 300₂/300₃ to 300₅ are connected through the terminal coupler 200₁/200₂ to perform group communication, the base station 400 allocates the same group identifier GID1/GID2 to the connection identifiers CID1 to CID5 of the terminals 300₁ and 300₂/300₃ to 300₅ connected to the terminal coupler 200₁/200₂ to perform group management. That is, the base station 400 allocates the group identifier GID1 to the connection identifiers CID1 and CID2 of the terminals 300₁ and 300₂, and allocates the group identifier GID2 to the connection identifiers CID3 to CID5 of the terminals 300₃ to 300₅.

The terminal equipment 100₁/100₂ is allocated an IP by using a dynamic host configuration protocol (DHCP) through the first terminal connected to the terminal coupler 200₁/200₂. The IP address can be shared by all terminals sharing the GID.

Accordingly, the base station 400 can realign packets received over a connection having connection identifiers belonging to the same group identifier according to the sequence numbers and transmit them to a network. Moreover, the base station 400 can search a corresponding identifier for downlink packets with the IP of the terminal equipment 100 and transmit the downlink packets over connections corresponding to the CIDs of the respective terminals belonging to the corresponding group identifier. At this point, base station 400 is able to assign sequence numbers to the downlink packets and transmit them over connections corresponding to the CIDs of the respective terminals.

The downlink packets transmitted to the respective terminals over the connections corresponding to the CIDs are forwarded to the terminal coupler 200, and the terminal coupler 200 realigns the received downlink packets according to the sequence numbers and forwards them to the terminal equipment 100.

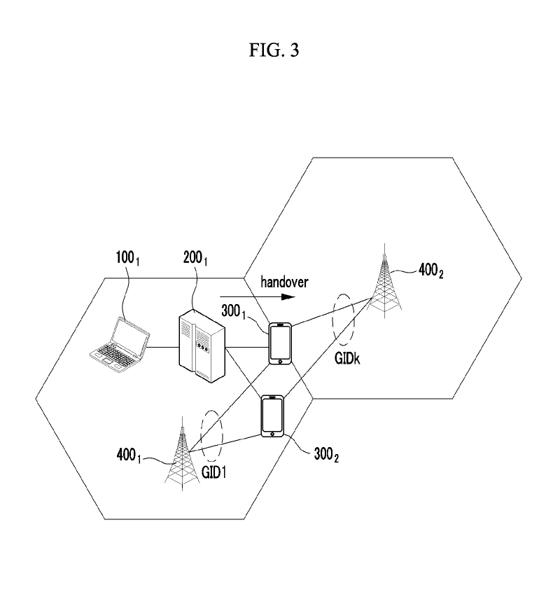

FIG. 3 is a view showing handover of a terminal connected to a terminal coupler according to an exemplary embodiment of the present invention.

In FIG. 3, there are illustrated the terminals 300₁ and 300₂ managed under the group identifier GID1, the terminal coupler 200₁ to which the terminals 300₁ and 300₂ are connected, and the terminal equipment 100₁ in FIG. 2.

Referring to FIG. 3, the terminals 300₁ and 300₂ perform group communication with the terminal equipment 100₁ and a serving base station 400₁ through the terminal coupler 200₁.

If the terminal equipment 100₁, the terminal coupler 200₁, and the terminals 300₁ and 300₂ move from a cell managed by the serving base station 400₁ to a cell managed by a target base station 400₂, the serving base station 400₁ detects the movement from the moving average group CINR of the terminals 300₁ and 300₂. As explained above, the serving base station 400₁ makes a handover decision if the moving average group CINR is less than a reference value.

Once a handover decision is made, the serving base station 400₁ performs a handover process of the terminals 300₁ and 300₂ according to a group handover trigger condition so that the terminals 300₁ and 300₂ can simultaneously perform handover to the target bas station 400₂.

Upon completion of the handover of the terminals 300₁ and 300₂, the serving base station 400₁ can forward packets received during the handover to the target base station 400₂ via a network 500.

Meanwhile, the terminals 300₁ and 300₂ having moved to the target base station 400₂ can be allocated new connection identifiers and a new group identifier GIDk from the target base station 400₂ by performing a network re-entry procedure with the target base station 400₂. The terminals 300₁ and 300₂ in the same group may be allocated the same group identifier GIDk. Otherwise, the terminals 300₁ and 300₂ having moved to the target base station 400₂ can be allocated the same group identifier GID1 as previously allocated from the target base station 400₂.

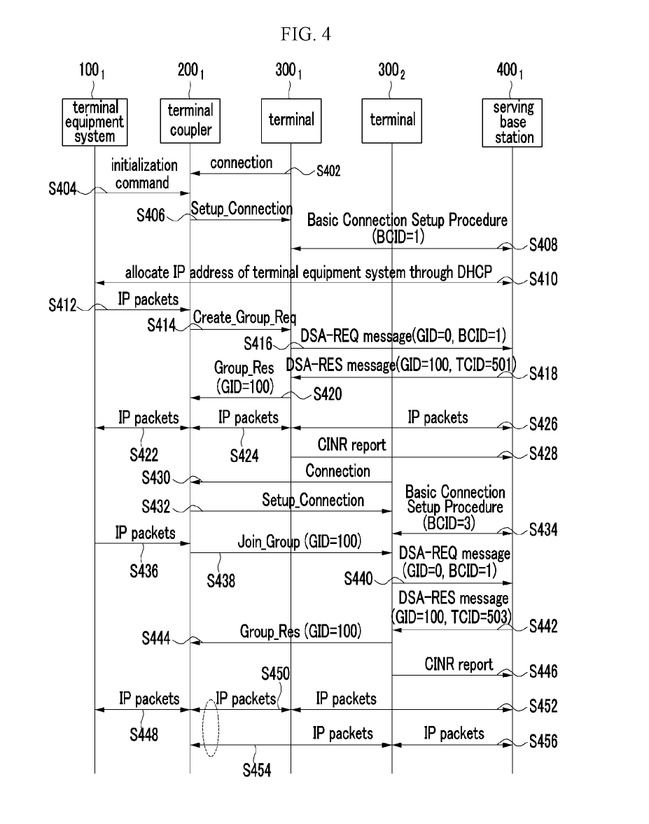

Next, a method for setting up a network connection for service provision with the terminals 300₁ and 300₂, the terminal coupler 200₁, the terminal equipment 100₁, and the serving base station 400₁ will be described in details with reference to FIG. 4.

FIG. 4 is a view showing a method for setting up a network connection in a mobile communication system according to an exemplary embodiment of the present invention.

Referring to FIG. 4, the terminal equipment 100₁ and the terminal coupler 200₁ are connected (attached) (S402), the terminal equipment 100₁ transmits an initialization command to the terminal 200₁ to initialize the terminal coupler 200₁ (S404).

The terminal coupler 200₁ transmits a Setup_Connection command (message) (S406).

Having received the Setup_Connection command, the terminal 300₁ performs a Basic Connection Setup Procedure with the serving base station 400₁ (S408) and sets up a Management Connection between the terminal 300₁ and the serving base station 400₁, and the terminal 300₁ is allocated a basic connection identifier (BCID=1) from the serving base station 400₁.

When a new terminal 300₁ is thusly connected, the terminal coupler 200₁ checks whether the terminal 300₁ is the first terminal attached to the terminal coupler 200₁. If the terminal 300₁ is the first terminal attached to the terminal coupler 200₁, the terminal equipment 100₁ is allocated an IP address from the serving base station 400₁ through DHCP (S410).

Then, when IP packets, which are uplink packets, are forwarded from the terminal equipment 100₁, the terminal coupler 200₁ transmits a Create_Group_Req command to the terminal 300₁ (S414).

On the other hand, if the terminal 300₁ is not the first terminal attached to the terminal coupler 200₁, the step S412 can be performed without performing the DHCP step S410.

The terminal 300₁ transmits a Dynamic Service Addition Request (hereinafter, referred to as “DSA-REQ”) message to the serving base station 400₁ (S416). At this point, the terminal 300₁ adds a basic connection identifier field and a group identifier field to the DSA-REQ message, and specifies a basic connection identifier (BCID=1) allocated thereto in the basic connection identifier field and a group identifier allocated thereto in the group identifier field. If no group identifier is allocated, the terminal 300₁ can specify a group identifier “GID=0” in the group identifier field.

Having received the DSA-REQ message, the serving base station 400₁ sets up a traffic connection with the terminal 300₁, and allocates a traffic connection identifier (TCID=501) for the terminal 300₁.

Moreover, if the group identifier field of the DSA-REQ message is GID=0, the serving base station 400₁ detects this as a Create New Group request, creates a group identifier (GID=100) for the terminal 300₁, and allocates the basic connection identifier (BCID=1) and traffic connection identifier (TCID=501) of the terminal 300₁ to the group identifier (GID=100).

The serving base station 400₁ transmits a Dynamic Service Addition Response (hereinafter, referred to as “DSA-RES”) message to the terminal 300₁ in response to the DSA-REQ message (S418). At this point, the serving base station 400₁ adds the group identifier field and the traffic connection identifier field to the DSA-RES message, and specifies the group identifier (GID=100) of the terminal 300₁ in the group identifier field and the traffic connection identifier (TCID=501) of the terminal 300₁ in the traffic connection identifier field.

Having received the DSA-RES message, the terminal 300₁ transmits the group identifier (GID=100) to the terminal coupler 200₁ through a group response (Group_Res) (S420).

Afterwards, upon receiving IP packets from the terminal equipment 100₁, (S412 and S422), the terminal coupler 200₁ transmits the IP packets to the terminal 300₁ (S424), and the terminal 300₁ transmits the IP packets to the serving base station 400₁ over a connection having the traffic connection identifier (TCID=501) (S426). Moreover, if there exist IP packets corresponding to downlink packets to be forwarded to the terminal equipment 100₁, the serving base station 400₁ transmits the IP packets to the terminal 300₁ over a connection having the traffic connection identifier (TCID=501) (S426), and the terminal 300₁ transmits the IP packets to the terminal equipment 100₁ through the terminal coupler 200₁ (S424 and S422).

When a connection setup between the terminal 300₁ and the serving base station 400₁ is completed, the terminal 300₁ periodically reports its CINR to the serving base station 400₁ (S428).

If a new terminal 300₂ is attached when the terminal 300₁ is thusly connected to the terminal coupler 200₁ (S430), the terminal coupler 200₁ transmits a Setup_Connection command to the terminal 300₁ like the previously described procedure (S432).

Having received the Setup_Connection command, the terminal 300₂ performs a Basic Connection Setup Procedure with the serving base station 400₁ (S434) and sets up a Management Connection between the terminal 300₂ and the serving base station 400₁, and the terminal 300₂ is allocated a basic connection identifier (BCID=3) from the serving base station 400₁.

Afterwards, upon receiving IP packets from the terminal equipment 100₁ (S436), the terminal coupler 200₂ transmits a Join_Group command to the terminal 300₂ in order to allow the terminal 300₂ to join a group with the group identifier (GID=100) (S438). The Join_Group command comprises the group identifier (GID=100). Moreover, prior to the step S438, the terminal coupler 200₂ performs the process of checking whether the attached terminal 300₂ is the first terminal attached to the terminal coupler 200₂. As is shown herein, the step S438 is performed without the DHCP process because the terminal 300₂ is not the first terminal attached to the terminal coupler 200₂.

Having received the Join_Group command, the terminal 300₂ forwards a DSA-REQ message to the serving base station 400₁ (S440). At this point, the terminal 300₁ adds a basic connection identifier field and a group identifier field to the DSA-REQ message, and specifies a basic connection identifier (BCID=3) allocated thereto in the basic connection identifier field and a group identifier (GID=100) allocated thereto in the group identifier field.

Having received the DSA-REQ message, the serving base station 400₁ sets up a traffic connection with the terminal 300₂, and allocates a traffic connection identifier (TCID=503) for the terminal 300₂.

Moreover, if the group identifier field of the DSA-REQ message is not GID=0, the serving base station 400₁ detects this as a Join Group request for joining the group with the corresponding group identifier (GID=100), and allocates the basic connection identifier (BCID=3) and traffic connection identifier (TCID=503) of the terminal 300₂ to the group identifier (GID=100).

In this way, the serving base station 400₁ is able to manage the terminals 300₁ and 300₂ connected to the terminal coupler 200₂ as one group.

Thereafter, the serving base station 400₁ transmits a DSA-RES message to the terminal 300₂ (S442). At this point, the serving base station 400₁ adds the group identifier field and the traffic connection identifier field to the DSA-RES message, and specifies the group identifier (GID=100) of the terminal 300₂ in the group identifier field and the traffic connection identifier (TCID=503) of the terminal 300₂ in the traffic connection identifier field.

Having received the DSA-RES message, the terminal 300₂ transmits the group identifier (GID=100) to the terminal coupler 200₁ through a group response (Group_Res) (S444).

In this way, after a connection setup between the terminal 300₂ and the serving base station 400₁ is completed, the terminal 300₂ periodically reports its CINR to the serving base station 400₁ (S446).

Upon receiving IP packets from the terminal equipment 100₁ (S448), the terminal coupler 200₁ assigns sequence numbers to the IP packets and transmits them to the terminals 300₁ and 300₂ (S450 and S454), the terminals 300₁ and 300₂ can forward the IP packets received from the terminal coupler 200₁ to the serving base station 400₁ over connections having the traffic connection identifiers (TCID=501 and TCID=503) (S452 and S456). Then, the serving base station 400₁ realigns the IP packets received over a connection having the same group identifier (GID=100) according to the sequence numbers and transmits them to the network.

Moreover, if there exist IP packets corresponding to uplink packets to be forwarded to the terminal equipment 100₁, the serving base station 400₁ assigns sequence numbers to the IP packets and transmits the IP packets to the terminals 300₁ and 300₂ over connections having the traffic connection identifiers (TCID=501 and TCID=503) (S452, S456), and the terminals 300₁ and 300₂ can transmit the IP packets to the terminal equipment 100₁ through the terminal coupler 2001 (S450, S454, and S448). That is, IP packets are sent and received between the terminal equipment 100₁ and the serving base station 400₁ by using the terminals 300₁ and 300₂ connected to the terminal coupler 200₁.

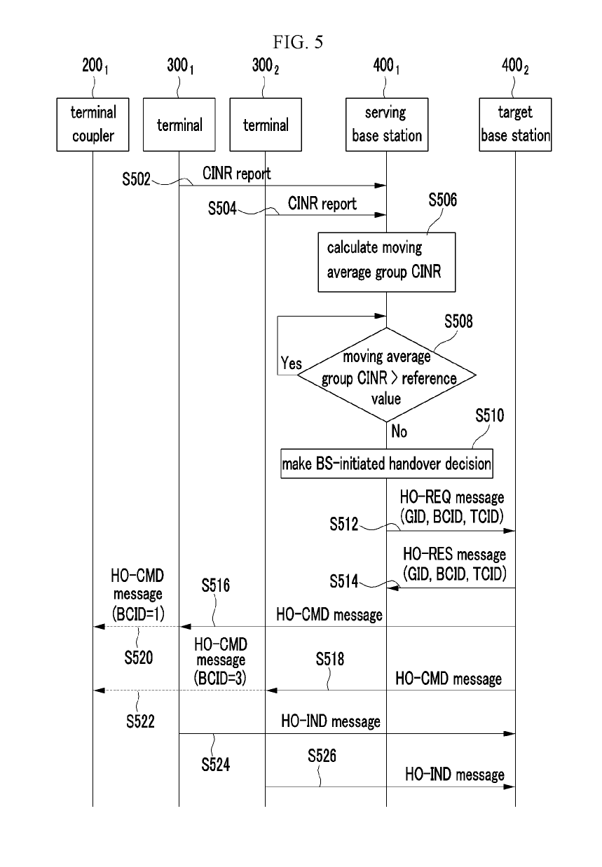

Next, a handover method of the terminals 300₁ and 300₂ connected to the terminal coupler 200₁ will be described in detail with reference to FIG. 5.

FIG. 5 is a view showing a handover method of a plurality of terminals connected to a terminal coupler according to an exemplary embodiment of the present invention.

Referring to FIG. 5, the serving base station 400₁ receives periodic reports of CINR from the terminals 300₁ and 300₂ connected to the terminal coupler 200₁.

Upon receiving a report of the CINRs of the terminals 300₁ and 300₂ belonging to the same group, the serving base station 400₁ calculates the moving average CINR of the corresponding group (hereinafter, referred to as “moving average group CINR”) (S506). Such a moving average group CINR can reduce an error caused by each of the terminals 300₁ and 300₂.

If the moving average group CINR is less than a reference value (S508), the serving base station 400₁ considers that a handover trigger condition is met, and makes a BS-initiated handover decision (S510). After making a BS-initiated handover decision, the serving base station 400₁ performs a BS-initiated handover procedure.

The serving base station 400₁ manages a list of neighboring base stations, called an Active set, and selects a target base station 400₂ from the Active set.

The serving base station 400₁ transmits a Handover Request (hereinafter, referred to as “HO-REQ”) message to the target base station 400₂ (S512), and the target base station 400₂ transmits a Handover Response (hereinafter, referred to as “HO-REQ”) to the serving base station 400₁ in response to the HO-REQ message (S514), thereby exchanging handover information required for handover and network re-entry. The HO-REQ message and the HO-RES message include information for the terminals 300₁ and 300₂ belonging to the same group. That is, the HO-REQ message and the HO-RES message may include the group identifier (GID=100), basic connection identifiers (BCID=1 and BCID=3), and traffic connection identifiers (TCID=501 and TCID=503) of the terminals 300₁ and 300₂ belonging to the same group. Moreover, the HO-REQ message and the HO-RES message may further include identification information of the terminals 300₁ and 300₂. The identification information of the terminals 300₁ and 300₂ is required for the target base station 400₂ to allocate the group identifier for the terminals 300₁ and 300₂ after the handover. A MAC address or the like can be used as the identification information of the terminals 300₁ and 300₂.

After the transmission and reception of the HO-REQ message and the HO-RES message between the serving base station 400₁ and the target base station 400₂ are completed, the serving base station 400₁ simultaneously transmits a Handover command (hereinafter, referred to as “HO-CMD”) message to the terminals 300₁ and 300₂ to indicate a simultaneous handover (S516 and S518).

Having received the HO-CMD message, the terminals 300₁ and 300₂ include their basic connection identifiers (BCID=1 and BCID=3) in the HO-CMD message and forward the HO-CMD message to the terminal coupler 200₁ (S520 and S522).

The terminals 300₁ and 300₂ having received the HO-CMD message execute an actual handover while transmitting a Handover Indication (hereinafter, referred to as “HO-IND”) message to the serving base station 400₁ (S524 and S526).

Having received the HO-IND message, the serving base station may release the connection setup with the terminals 300₁ and 300₂, and may hold information related to the terminals 300₁ and 300₂ for a certain amount of time to ensure service continuity. That is, the terminals 300₁ and 300₂ cannot receive any more packets through the serving base station after the transmission timing of the HO-IND message, and therefore quickly perform a network re-entry procedure with the target base station. During the network re-entry procedure, the serving base station can maintain IP packet communication with the terminals 300₁ and 300₂.

After the terminal 300₁ and 300₂ normally complete the network re-entry procedure with the target base station 400₂, the target base station 400₂ allocates new basic connection identifiers (BCID=5 and BCID=7) and new traffic connection identifiers (TCID=505 and TCID=507) to the terminals 300₁ and 300₂. Moreover, the target base station 400₂ allocates the same group identifier (GID=100) to the terminals 300₁ and 300₂ using the identification information of the terminals 300₁ and 300₂. Although the group identifier (GID=100) may be different from the previous one, the terminals 300₁ and 300₂ have the same group identifier.

Afterwards, the terminals 300₁ and 300₂ perform communication with the terminals 300₁ and 300₂ over this connection.

After the handover, the terminals 300₁ and 300₂ periodically report their CINR to the target base station 400₂, and the target base station 400₂ calculates the moving average group CINR of the terminals 300₁ and 300₂ reported from the terminals 300₁ and 300₂ and decides whether to perform handover.

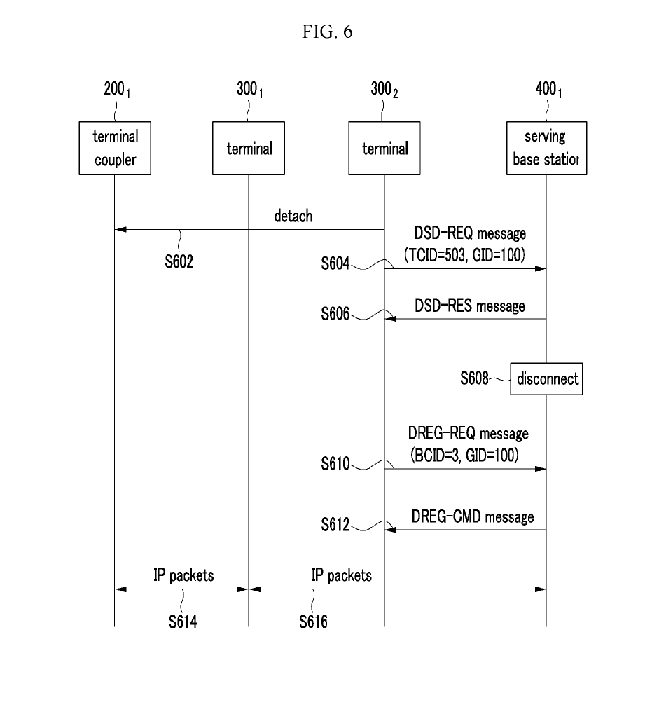

Next, a method for disconnecting the terminal 300₂ connected to the terminal coupler 200₁ will be described in detail with reference to FIG. 6.

FIG. 6 is a view showing a method for disconnecting a terminal connected to a terminal coupler according to an exemplary embodiment of the present invention.

FIG. 6 assumes that the terminal 300₁ with the connection identifier (BCID=1 and TCID=501) and the terminal 300₂ with the connection identifier (BCID=3 and TCID=503) are connected to the terminal coupler 200₁, and the group identifier of the terminals 300₁ and 300₂ is GID=100.

Referring to FIG. 6, the terminals 300₁ and 300₂ can perform group communication with the terminal equipment 100₁ and the serving base station 400₁ through the terminal coupler 200₁ in the method explained in FIG. 5.

At this point, if the connection (attachment) between the terminal coupler 200₁ and the terminal 300₂ is released (S602), the terminal 300₂ transmits a Dynamic Service Delete Request (hereinafter, referred to as “DSD-REQ”) message to the serving base station 400₁ (S604). Hereupon, the terminal 300₂ includes the traffic connection identifier (TCID=503) and the group identifier (GID=100) allocated thereto in the DSD-REQ message and forwards the DSD-REQ message to the serving base station 400₁. Hence, the terminal 300₂ notifies the serving base station 400₁ that the traffic connection identifier (TCID=503) is released from the group with the group identifier (GID=100).

Having received the DSD-REQ message, the serving base station 400₁ checks the traffic connection identifier (TCID=503) of the traffic connection identifier field of the DSD-REQ message, and transmits a Dynamic Service Delete Response (hereinafter, referred to as “DSD-RES”) message to the terminal 300₂ in response to the DSD-REQ message (S606). Next, the serving base station 400₁ releases the connection having the traffic connection identifier (TCID=503) S608.

The terminal 300₂ forwards a De-registration Request (hereinafter, referred to as “DREG-REQ”) to the serving base station 400₁ (S610), and the serving base station 400₁ having received the DREG-REQ message transmits a De-registration Command (hereinafter, referred to as “DREG-COM”) to the terminal 300₂ (S612), thereby releasing the connection setup between the terminal 300₂ and the serving base station 400₁. Hereupon, the terminal 300₂ includes the basic connection identifier (BCID=3) and the group identifier (GID=100) in the DREG-REQ message and forwards the DREG-REQ message to the serving base station 400₁. Hence, the terminal 300₂ notifies the serving base station 400₁ that the basic connection identifier (BCID=503) is released from the group with the group identifier (GID=100).

Afterwards, the terminal coupler 200₁ is able to transmit and receive IP packets to and from the serving base station 400₁ using the connection identifier of the terminal 300₁ connected to the terminal coupler 200₁ (S614 and S616).

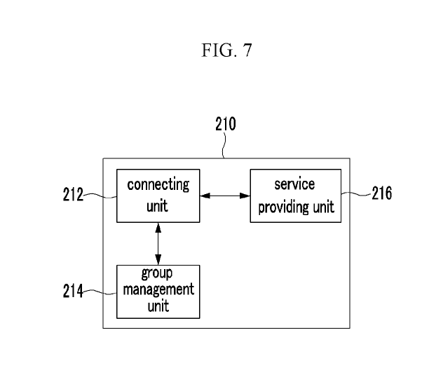

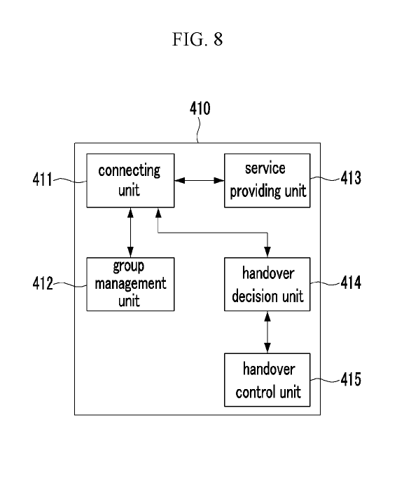

The terminal coupler 200₁ and the serving base station 400, that enable the above-described operation will be described in detail with reference to FIGS. 7 and 8.

FIG. 7 is a view showing a terminal coupler according to an exemplary embodiment of the present invention. FIG. 8 is a view showing a base station according to an exemplary embodiment of the present invention.

The reference numerals in FIG. 7 and FIG. 8 are assigned with respect to FIG. 1.

Also, in FIG. 7 and FIG. 8, a terminal coupler 200 and a base station 400 each comprises a group communication apparatus 210 and 410. Otherwise, the group communication apparatus 210 may be the terminal coupler 200, and the group communication apparatus 410 may be the base station 400.

First, referring to FIG. 7, the group communication apparatus 210 comprises a connecting unit 212, a group management unit 214, and a service providing unit 216.

The connecting unit 212 sets up a connection with a terminal equipment 10 and a plurality of terminals 300₁ to 300ₙ in the method as explained in FIG. 4.

The group management unit 214 checks the first terminal attached thereto among the plurality of terminals 300₁ to 300ₙ when the plurality of terminals 300₁ to 300ₙ are attached, requests the base station 400 to create a group for the first terminal attached thereto and receives a group identifier from the base station 400, and issues a Join Group request to the base station 400 so that a subsequently attached terminal joins the group with the same group identifier as the first attached terminal. In this manner, the group management unit 214 manages the plurality of terminals 300₁ to 300ₙ connected to the terminal coupler 200 in one group.

The service providing unit 212 assigns sequence numbers to uplink packets received from a terminal equipment 100 and forwards the downlink packets to the terminals 300₁ to 300ₙ according to a scheduling policy, and receives downlink packets from the terminals 300₁ to 300ₙ, realigns the downlink packets according to the sequence numbers, and forwards the downlink packets to the terminal equipment 100.

Next, referring to FIG. 8, the group communication apparatus 410 comprises a connecting unit 411, a group management unit 411, a service providing unit 413, a handover decision unit 414, and a handover control unit 415.

The connecting unit 411 sets up a connection with the plurality of terminals 300₁ to 300ₙ that has issued a connection setup request. At this point, the connecting unit 411 allocates respective connection identifiers to the plurality of terminals 300₁ to 300ₙ.

The group management unit 412 checks the connection identifier field and group identifier field of the DSA-REQ message received from the plurality of terminals 300₁ to 300ₙ, and determines from the value of the group identifier field whether a Create Group request or a Join Group request is issued. If a Create Group request is issued, the group management unit 412 creates a group identifier and allocates the connection identifier of a corresponding terminal to the group identifier. Also, if a Join Group request is issued, the group management unit 412 allocates the connection identifier included in the connection identifier field to the group identifier included in the group identifier field. In this way, the group management unit 412 allocates one group identifier to the plurality of terminals 300₁ to 300ₙ connected to the terminal coupler 200 and manages them in one group.

Also, the group management unit 412 releases the connection identifier of a terminal, which is disconnected from the terminal coupler 200 released, among the plurality of terminals 300₁ to 300ₙ with one group identifier, from the corresponding group identifier.

Upon receiving uplink packets from the plurality of terminals 300₁ to 300ₙ with the same group identifier, the service providing unit 413 realigns the uplink packets according to the sequence numbers of the uplink packets and transmits them to a network. Moreover, upon receiving downlink packets to be transmitted to the terminal equipment 100 from the network, the service providing unit 413 assigns sequence numbers to the downlink packets and transmits them to the terminals 300₁ to 300ₙ according to a scheduling policy.

The handover decision unit 414 periodically receives CINR from the plurality of terminals 300₁ to 300ₙ with the same group identifier, calculates the moving average group CINR, and makes a BS-initiated handover decision if the moving average group CINR is less than a reference value.

When a BS-initiated handover decision is made by the handover decision unit 414, the handover control unit 415 controls the handover of the plurality of terminals 300₁ to 300ₙ so that the plurality of terminals 300₁ to 300ₙ simultaneously perform handover to a target base station. First, the handover control unit 415 selects the target base station from a list of neighboring base stations, and exchanges handover information with the target base station. Next, the handover control unit 415 simultaneously transmits a HO-CMD message to the plurality of terminals 300₁ to 300ₙ to indicate a simultaneous handover. Then, upon receiving an HO-IND message from the plurality of terminals 300₁ to 300ₙ, the handover control unit 415 releases the connection setup with the plurality of terminals 300₁ to 300ₙ.

According to an exemplary embodiment of the present invention, a high-capacity and high-speed service that is not supported by a single terminal can be provided to a terminal equipment by coupling a plurality of terminals by a terminal coupler. At this point, the handover timing and target base station of the plurality of terminals may be the same because the plurality of terminals simultaneously perform handover.

The exemplary embodiments of the present invention described above are not only implemented by the method and apparatus, but it may be implemented by a program for executing the functions corresponding to the configuration of the exemplary embodiment of the present invention or a recording medium having the program recorded thereon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of group communication in a base station, the method comprising:
allocating respective connection identifiers to a plurality of terminals connected to a terminal coupler;
allocating the same group identifier to the connection identifiers of the plurality of terminals;
upon receiving uplink packets of a terminal equipment from the plurality of terminals through the terminal coupler, realigning the uplink packets according to the sequence numbers of the uplink packets and transmitting the uplink packets to a network; and
upon receiving downlink packets directed to the terminal equipment from the network, assigning sequence numbers to the downlink packets and transmitting the downlink packets to the plurality of terminals.

2. The method of claim 1, further comprising making a handover decision for the plurality of terminals using communication quality information of the plurality of terminals.

3. The method of claim 2, wherein the decision making comprises:
calculating the moving average of the communication quality information of the plurality of terminals with the same identifier; and
if the moving average is less than a reference value, making the handover decision.

4. The method of claim 3, wherein the decision making further comprises receiving the communication quality information from the plurality of terminals prior to the calculating.

5. The method of claim 2, wherein the communication quality information comprises carrier to interference noise ratio (CINR).

6. The method of claim 2, further comprising:
if the handover decision is made, selecting a target base station from a list of neighboring base stations; and
instructing the plurality of terminals to perform a BS-initiated handover.

7. The method of claim 6, wherein the instructing comprises simultaneously transmitting, to the plurality of terminals, a handover command message for indicating a simultaneous handover to the target base station.

8. The method of claim 7, further comprising exchanging handover information with the target base station prior to the transmitting of the handover command message,
wherein the handover information comprises the group identifier and the connection identifiers of the plurality of terminals.

9. The method of claim 8, wherein the handover information further comprises identification information of the plurality of terminals, and
the target base station allocates the same group identifier to the plurality of terminals using the identification information of the plurality of terminals.

10. The method of claim 7, further comprising, upon receiving a handover indication message from the plurality of terminals having received the handover command message, transmitting downlink packets received during the handover to the target base station.

11. The method of claim 1, wherein each of the connection identifiers comprises a basic connection identifier and a traffic connection identifier.

12. An apparatus of group communication in a base station, the apparatus comprising:
a connecting unit that sets up a connection with a plurality of terminals connected to a terminal coupler and allocates connection identifiers to the plurality of terminals;
a group management unit that allocates the same group identifier to the connection identifiers of the plurality of terminals connected to the terminal coupler and manages the plurality of terminals in one group;
a handover decision unit that receives communication quality information from the plurality of terminals of the group, calculates the moving average of the communication quality information, and makes a handover decision for the plurality of terminals of the group if the moving average is less than a reference value.

13. The apparatus of claim 12, further comprising a handover control unit that controls the plurality of terminals to simultaneously perform handover to a target base station if a handover decision for the plurality of terminals in the group is made.

14. The apparatus of claim 13, wherein the handover control unit exchanges handover information, and
the handover information comprises connection identifiers of the plurality of terminals and a group identifier of the plurality of terminals.

15. The apparatus of claim 14, wherein the handover control unit simultaneously forwards a handover command message to the plurality of terminals of the group to indicate a simultaneous handover to the target base station.

16. The apparatus of claim 12, further comprising a service providing unit that realigns uplink packets of a terminal equipment received through the terminal coupler and the plurality of terminals according to the sequence numbers and transmits the uplink packets to a network, and assigns sequence numbers to downlink packets directed to the terminal equipment from the network and transmits the downlink packets to the plurality of terminals.

17. The apparatus of claim 12, wherein, if at least one of the plurality of terminals is disconnected from the terminal coupler, the group management unit releases the connection identifier of the at least one terminal from the group identifier

18. An apparatus for performing group communication, the apparatus comprising:
a connecting unit that sets up a connection with a terminal equipment and a plurality of terminals independently access to a base station;
a group management unit that manages the plurality of terminals in one group;
a service providing unit that assigns sequence numbers to uplink packets received from the terminal equipment and forwards the uplink packets to the plurality of terminals according to scheduling, and receives downlink packets assigned with sequence numbers from the plurality of terminals, realigns the downlink packets according to the sequence numbers, and forwards the downlink packets to the terminal equipment.

19. The apparatus of claim 18, wherein the connecting unit transmits a create group request command to the first terminal attached thereto among the plurality of terminals and receives the group identifier of the first terminal, and transmits a join group command to the second terminal other than the first terminal attached thereto and allows the second terminal to join the group with the group identifier of the first terminal.

20. The apparatus of claim 19, wherein the join group command comprises the group identifier of the first terminal.
